(19) United States
(12) Patent Application Publication
(10) Pub. No.: US 2008/0008541 A1
(43) Pub. Date: Jan. 10, 2008

(54) Dry Grout Composition And Capsule For Anchoring Reinforcing Member, Dowel Or Anchor Elements

(76) Inventor: Jacques Bertrand, Baie D'Urfe (CA)

Correspondence Address: BUCHANAN, INGERSOLL & ROONEY PC, POST OFFICE BOX 1404, ALEXANDRIA, VA, 22313-1404, US

(21) Appl. No.: 11/859,340

(22) Filed: Sep. 21, 2007

Related U.S. Application Data
(63) Continuation of application No. PCT/CA2006/000443, filed on Mar. 24, 2006.
(60) Provisional application No. 60/664,698, filed on Mar. 24, 2005.

(51) Int. Cl. C04B 28/06; E21D 21/00; C04B 7/32

(52) U.S. Cl. 405/259.5; 106/692; 106/694; 106/695

(57) ABSTRACT

The present invention relates to a dry grout composition comprising a calcium aluminosulfate based hydraulic cement, a mineral filler, a thixotropic agent, and a superplasticizer agent. An anchoring capsule, containing the dry grout composition, for use in anchoring reinforcing member dowel, or anchor elements in a hole of a substrate, and a method of use is also provided.

### CROSS REFERENCE TO RELATED APPLICATION

This application claims the benefit of U.S. provisional application No. 60/664,698 filed Mar. 24, 2005 which is incorporated herein by reference in its entirety.

### FIELD OF THE INVENTION

The invention relates to dry grout composition and capsule for anchoring reinforcing member, dowel or anchor elements in a hole of a substrate such as concrete, rock or soil.

### BACKGROUND OF THE INVENTION

Numerous materials are used to bond reinforcing or anchoring elements to existing substrate and include cementitious grouts with ordinary type 1* or high early type 3* (* ASTM C-150 designation) cements, calcium aluminate cements (CAC), synthetic resin based components grouts as well as epoxy based materials. The above mentioned grouts can mixed on site prior to being poured in the drilled hole or they may be packaged in a pressure sensitive frangible cartridge or glass tube which will break upon introduction of the reinforcing or anchoring element.

Also, various mechanical anchoring devices are also used to anchor reinforcing and anchoring elements in the substrate. Each material and system has its own particularities and limitations.

One anchoring system that is being used is composed of a grout made with calcium aluminate cement (CAC) encapsulated in an unwoven polyester capsule that is used in the mines and construction projects. The rapid setting is achieved through the use of CAC which typically contain 36 to 42% Al₂O₃ and has been used primarily in mines in South Africa where the in situ temperatures of the substrate can be as high as 50° C. CAC grouts are not accepted for structural applications in many countries principally in the UK and Europe.

Resin or epoxy based materials are not suitable for these applications as they will creep and deform with time and these materials are sensitive to humidity. Cartridges containing unsaturated polyester resin and epoxy systems exhibit high toxicity and flammability in an enclosed environment and disposing of excess materials and packaging material can be hazardous to the environment.

Mechanical anchors can provide an adequate solution to anchor reinforcing and anchoring elements in the substrate but they are installed at the end of the anchoring element in the drilled hole and leave it exposed to corrosion and can lead to failure over the long term especially in underground structures and in areas subjected to freeze-thaw conditions and in saline or acidic or corrosive environments. Normally the cavity between the wall of the drilled hole and the reinforcing or anchoring elements using mechanical anchors is grouted with a cementitious grout.

It is known that a number of cement clinkers contain up to 50-300 ppm of chromium (VI) compounds. Chromium (VI) compounds have a high water solubility and can therefore come in contact with the skin of workers during handling of wet mortar or concrete. A number of countries have now adopted regulations requiring cements with reduced amount of chromium (VI). Those chromium (VI) compounds are classified as extremely toxic because of their high oxidation potential as well as their ability to penetrate human tissue and potentially cause sensitization and allergic eczema (dermatitis).

There is therefore a great need for improved grouts, as well as improved handling processes and formulations.

### SUMMARY OF THE INVENTION

In one aspect, the invention provides a dry grout composition comprising:
a calcium aluminosulfate based hydraulic cement;
a mineral filler;
a thixotropic agent; and
a superplasticizer agent.

In one aspect, the invention provides a dry grout composition comprising:
a calcium aluminosulfate based hydraulic cement;
a mineral filler;
a thixotropic agent;
a superplasticizer agent;
an air entraining agent; and
optionally flyash and/or silica fume.

In a further aspect there is provided an anchoring capsule for use in anchoring reinforcing member dowel, or anchor elements in a hole of a substrate, the capsule comprising:
a water permeable encapsulating means; and
a grout composition as defined herein, said grout composition being encapsulated within said encapsulating means.

In a further aspect there is provided a method for anchoring reinforcing member, dowel or anchor elements in a hole of a substrate comprising:
providing an anchoring capsule by introducing a dry grout composition as defined herein in a water permeable encapsulating means;
soaking said capsule in an aqueous solution;
introducing said capsule in the hole; and
introducing a reinforcing member, dowel or anchor elements in the capsule before any substantial hardening has occurred.

In a further aspect there is provided a method for anchoring reinforcing member, dowel or anchor elements in a hole of a substrate comprising:
providing a grout composition as defined herein;
wetting said composition with an aqueous solution; and
introducing a reinforcing member, dowel or anchor elements in the hole containing the wet composition before any substantial hardening has occurred.

In still a further aspect, there is provided a method for anchoring reinforcing member, dowel or anchor elements in a hole of a substrate comprising:
providing a grout composition as defined herein in a capsule;
wetting said composition with an aqueous solution and introducing said capsule in the hole; and
introducing the reinforcing member, dowel or anchor elements in the capsule before any substantial hardening has occurred.

In still a further aspect, there is provided a method for anchoring reinforcing member, dowel or anchor elements in a hole of a substrate comprising:
providing a grout composition as defined herein;
wetting said composition with an aqueous solution;
introducing said wet composition in the hole; and
introducing the reinforcing member, dowel or anchor elements in the composition before any substantial hardening has occurred.

### BRIEF DESCRIPTION OF THE DRAWINGS

The invention can be better described with reference to the following drawings, wherein:

FIG. 1 represents an anchoring capsule in accordance with one embodiment of the present invention;

FIG. 2 is a cross sectional view of FIG. 1;

FIG. 3 is a cross sectional view of a substrate with a drilled hole;

FIG. 4 is a cross sectional view of a substrate with a drilled hole and an anchoring capsule in accordance with one embodiment of the present invention;

FIG. 5 is the same view as FIGS. 3 and 4 with a rebar introduced in the hole of the substrate.

### DETAILED DESCRIPTION OF THE INVENTION

While the making and using of the various embodiments are discussed below, it should be appreciated that the specific embodiments discussed herein are merely illustrative of specific ways of making and using the invention and should not be construed as to limit the scope of the invention.

In one embodiment, the grout composition according to the invention is further comprising an air entraining agent.

In one embodiment, the grout composition is further comprising flyash, silica powder or a mixture thereof.

In one embodiment, the invention provides a grout composition comprising:
a calcium aluminosulfate based hydraulic cement from about 40% to about 70%;
a mineral filler from about 30% to about 60%;
a thixotropic agent from trace amount to about 5%;
a superplasticizer agent from trace amount to about 5%;
an air entraining agent from trace amount to about 5%;
optionally flyash and/or silica fume from trace amount to about 10%;
optionally an accelerating or retarding agent from trace amount to about 5%;
said amount being based upon the total dry weight of said composition for a total of 100%.

In a further embodiment, the invention provides a grout composition comprising:
a calcium aluminosulfate based hydraulic cement from about 40% to about 60%;
a mineral filler from about 40% to about 60%;
a thixotropic agent from trace amount to about 3%;
a superplasticizer agent from trace amount to about 3%;
an air entraining agent from trace amount to about 3%;
optionally flyash and/or silica fume from trace amount to about 10%;
optionally an accelerating or retarding agent from trace amount to about 5%;
said amount being based upon the total dry weight of said composition for a total of 100%.

In a further embodiment, the invention provides a grout composition comprising:
a calcium aluminosulfate based hydraulic cement from about 40% to about 60%;
a mineral filler from about 40% to about 60%;
a thixotropic agent from trace amount to about 2%;
a superplasticizer agent from trace amount to about 2%;
an air entraining agent from trace amount to about 2%;
optionally flyash and/or silica fume from trace amount to about 10%;
optionally an accelerating or retarding agent from trace amount to about 5%;
said amount being based upon the total dry weight of said composition for a total of 100%.

In a further embodiment, the invention provides a grout composition comprising: a calcium aluminosulfate based hydraulic cement about 40% to about 50%
a mineral filler at about 45% to about 55%;
a thixotropic agent at about less than 1%;
a superplasticizer agent at about less than 2%; and
an air entraining agent at about less than 1%;
optionally flyash and/or silica fume from trace amount to about 10%;
optionally an accelerating or retarding agent from trace amount to about 5%;
said amount being based upon the total dry weight of said composition for a total of 100%.

Advantageously, the grout composition according to the invention may contain substantially less alumina than typically used by those in the field.

Therefore, in one embodiment:
the cement contains less that 60% of alumina;
the cement contains less that 50% of alumina;
the cement contains less that 40% of alumina;
the cement contains less that 30% of alumina;
the cement contains between about 10% and about 25% of alumina;
the cement contains between about 14% and about 16% of alumina;
the cement contains about 15% of alumina.

In further embodiments:
the grout composition contains from about 0.01% to about 5% thixotropic agent;
the grout composition contains from about 0.1% to about 4% thixotropic agent;
the grout composition contains about 2% thixotropic agent;
the grout composition contains about 1% thixotropic agent;
the grout composition contains less than about 1% thixotropic agent;
the grout composition contains less than about 0.1% thixotropic agent;
said amount being based upon the total dry weight of said composition for a total of 100%.

In one embodiment, the thixotropic agent includes cellulose-based colloidal agent.

In one embodiment, the thixotropic agent is selected from cellulose or welan gum.

In further embodiments:
the grout composition contains from about 30% to about 60% mineral filler;
the grout composition contains from about 40% to about 60% mineral filler;
the grout composition contains from about 45% to about 55% mineral filler;
the grout composition contains about 54% mineral filler;
said amount being based upon the total dry weight of said composition for a total of 100%.

In another embodiment, the mineral filler is sand.

In further embodiments:
the grout composition contains from about 40% to about 70% calcium aluminosulfate based hydraulic cement;
the grout composition contains from about 40% to about 60% calcium aluminosulfate based hydraulic cement;
the grout composition contains from about 40% to about 50% calcium aluminosulfate based hydraulic cement;
the grout composition contains about 45% calcium aluminosulfate based hydraulic cement;
said amount being based upon the total dry weight of said composition for a total of 100%.

In one embodiment, the flyash is class F flyash and/or silica fume compliant with ASTM C 1240.

In one embodiment, the superplasticizer agent is melamine sulfonate based plasticizer (Melment F-10 ®).

In further embodiments:
the grout composition contains from about 0.01% to about 5% superplasticizer;
the grout composition contains from about 0.1% to about 4% superplasticizer;
the grout composition contains less than about 2%
superplasticizer;
said amount being based upon the total dry weight of said composition for a total of 100%.

In further embodiments:
the grout composition contains from about 0.01% to about 5% air entraining agent;
the grout composition contains from about 0.1% to about 4% air entraining agent;
the grout composition contains about less than 1% air entraining agent;
said amount being based upon the total dry weight of said composition for a total of 100%.

In one embodiment, the air entraining agent is NVX resin.

In one embodiment, the dry grout composition is further comprising a chromium(VI)-reducing agent.

In one embodiment, the chromium(VI)-reducing agent is stannous sulfate or ferrous sulfate.

In one embodiment, the chromium(VI)-reducing agent is stannous sulfate.

In one embodiment, the chromium(VI)-reducing agent is ferrous sulfate.

In one embodiment, the grout composition contains from about 0.01% to about 100% of the chromium(VI)-reducing agent.

In one embodiment, the grout composition contains from about 0.01% to about 10% of the chromium(VI)-reducing agent.

In one embodiment, the grout composition contains from about 0.1% to about 1% of the chromium(VI)-reducing agent.

In one embodiment, the grout composition contains from about 0.1% to about 0.5% of the chromium(VI)-reducing agent.

In one embodiment, the grout composition contains from about 0.3% to about 0.35% of the chromium(VI)-reducing agent.

The term “thixotropic agent” means a substance that makes the hydrated grout composition become less fluid, stiffer and more cohesive when the dry grout is activated with water or any suitable aqueous solution. Typical thixotropic agent includes cellulose-based colloidal agent. A commercial agent is EUCO-NIVO P® manufactured by Euclid Admixture Canada inc. The thixotropic agent is added to obtain the thixotropic consistency required to ensure grout does not sag or run out of drilled hole. This characteristic is especially important for horizontal and overhead installation of anchoring elements.

The term “Flyash” means a finely divided mineral residue resulting from the combustion of ground or powdered coal in electric generating plant (ASTM C 618). Flyash consists of inorganic matter present in the coal that has been fused during coal combustion. Flyash is a pozzolanic material and has been classified into two classes, F and C, based on the chemical composition of the flyashes defined in ASTM C 618.

The term “ASTM” means American Society of Testing Materials.

The term “calcium aluminosulfate based hydraulic cement” refers to a cement composition formed by an expansive clinker which includes a stable calcium alumina-sulfate and a cement clinker or gypsum. The cement may be prepared based on methods known in the art and particularly using methods described in Canadian patent number CA 1 197 270. Typical cement preparation advantageously used in one embodiment of the invention is Rapid Set® cement by CTS Cement which is included in the premixed Cement All® grout manufactured by CTS Cement which contains appropriate amounts of a superplasticizer agent, an air entraining agent and mineral filler. Those skilled workmen in the field will readily understand that the specific amount of water used may vary depending on the chemical composition of different batches. However it is possible to adjust the other elements of the composition to practice the invention.

The term “water permeable encapsulating means” will be understood to be any suitable container allowing for containing the dry grout composition and allowing an aqueous solution (including water) to penetrate within the container to soak the dry grout composition as defined herein. The suitable container should be selected to maintain its physical integrity and as such substantially retain the dry and wet composition during manipulation and further have the ability of being ruptured in the hole of a substrate by the introduction of a reinforcing member, dowel or anchor elements and be integrated into the mix. The container may be made of unwoven polyester wrapping, polymer, paper or a combination of same.

The term “alumina” means an aluminum compound of formula Al₂O₃.

The term “wetting” or “wet” means providing water or any suitable aqueous solution in contact with the grout composition to obtain an effective water/cement ratio. A water/cement ratio provided by the soaking operation or otherwise is selected to provide the desired consistency to the wet composition. Generally, it is desirable to have the lowest water/cement ratio. A typical ratio will be from about 0.25 to about 0.5. Alternatively, it may be of from about 0.26 to about 0.45.

The expression “reinforcing member, dowel or anchor elements” is well known to the skilled workman and should not be construed as limited by the enumeration. In general, elements to be anchored in a hole of a substrate may also be referred to as load transferring element, reinforcing steel, rebar threaded bolt, dowel, anchor bolt or rock bolt.

The expression “chromium(VI)-reducing agent” means a transition metal salt having the ability to reduce a chromium(VI) species into chromium(III). Such reducing agents include without limitation stannous sulfate or ferrous sulfate as well as their hydrates and/or solvates such as ferrous sulfate mono- or hepta-hydrate. The amount of reducing agent required can be determined by measuring the chromium (VI) content in a cement using techniques known in the art and adding the appropriate amount of reducing agent. The amount % used herein was based upon the total dry weight of the dry grout composition (i.e. cement, filler, thixotropic agent and if any superplasticizer agent, air entraining agent and flyash and/or silica fume.

As used herein, the term “air entraining agent” refers to agents known in the art of concrete and cause a substantial improvement in durability and none of the essential properties of the concrete should be seriously impaired. Requirements and specifications of air-entraining agents to be used in concrete are covered in ASTM C 260 and AASHTO M 154. Four groups of air entraining agents are generally identified: 1) salts of wood resins, 2) synthetic detergents, 3) salts of petroleum acids, and 4) fatty and resinous acids and their salts.

As used herein, the term “superplasticizers” refers to agents known in the art of concrete that fluidifies the mix before it hardens, increasing its workability, reducing the water/cement ratio and are usually not intended to affect the properties of the final product after it hardens. Superplasticizers are commonly manufactured from lignosulfonates, sulfonated naphthalene formaldehyde, sulfonated melamine formaldehyde, or polycarboxylic ethers.

As used herein, the term “silica fume” refers to very fine pozzolanic material, composed mostly of amourphous silica produced by electric arc furnaces as a byproduct of the production of elemental silicon or ferrosilicon alloys (also known as condensed silica fume and microsilica). Requirements and specifications of silica fume to be used are covered in ASTM C 1240.

Also it is possible to determine the time for strength development as this will determine how soon the anchoring element can accept a load and also how much it can accept.

One criteria in designing an anchoring grout is the bond strength developed to resist pull out. The design limit to be obtained must be the load at the elastic limit of the reinforcing or anchoring element so as to ensure that it is the reinforcing or anchor element that yields and becomes the weak point in the anchoring system. The bond strength developed by the anchoring grout must therefore be greater than the elastic limit of the reinforcing or anchoring element. To achieve this, the anchoring grout must not shrink and completely fill the drilled hole once the reinforcing or anchoring element is introduced and encapsulate it. Thus it is important to have a stiff and homogeneous thixotropic non-shrink grout mix to ensure the grout does not substantially run out of the drilled hole.

It is advantageous that the grout has a fast setting time so as to place loads on reinforcing or anchoring elements in the shortest delay possible.

In one aspect of the invention, there is provided an anchoring capsule for use in anchoring a reinforcing member, dowel or anchor elements in a hole of a substrate, the capsule comprising:
a water permeable encapsulating means; and
a dry grout composition as defined herein,
said grout composition being encapsulated within said encapsulating means.

In one embodiment, the encapsulating means is made of polyester.

In one embodiment, the encapsulating means is made of unwoven polyester.

Typically, the anchoring capsule is prepared by pre-mixing all of the desired components of the dry grout composition and adding into the encapsulating means. The encapsulating means may have various shapes and sizes such as a sleeve, a pouch or any convenient shape. The dry grout composition may be added to the encapsulating means manually, automatically or in part manually and automatically using dry material filling apparatus.

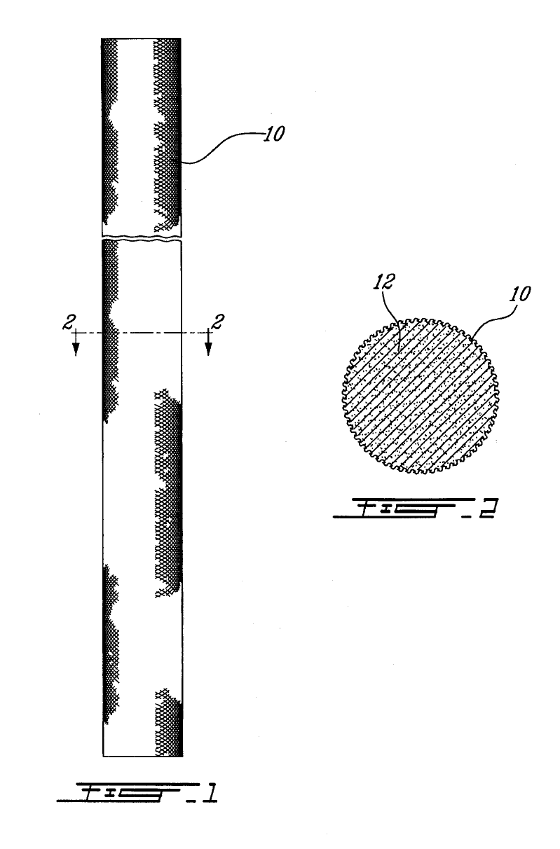

FIG. 1 represents one embodiment of the present invention in which 10 is an elongated unwoven polyester encapsulating means. FIG. 2 shows a cross sectional view of the representation of FIG. 1, with a dry grout composition 12 encapsulated within 10.

In one aspect of the invention, there is provided a method for anchoring reinforcing member, dowel or anchor elements in a hole of a substrate comprising:
providing an anchoring capsule as defined herein;
soaking said capsule in an aqueous solution,
introducing said capsule in the hole; and
introducing the reinforcing member, dowel or anchor elements in the capsule before any substantial hardening has occurred.

In one aspect of the invention, there is provided a method for anchoring reinforcing member, dowel or anchor elements in a hole of a substrate comprising:
providing a grout composition as defined herein in a capsule;
soaking said capsule in an aqueous solution, introducing said capsule in the hole; and
introducing the reinforcing member, dowel or anchor elements in the capsule before any substantial hardening has occurred.

In one aspect of the invention, there is provided a method for anchoring reinforcing member, dowel or anchor elements in a hole of a substrate comprising:
providing a grout composition as defined herein in a capsule;
wetting said composition with an aqueous solution;
introducing said capsule in the hole; and
introducing a reinforcing member, dowel or anchor elements in the capsule before any substantial hardening has occurred.

In one embodiment, the ratio of aqueous solution to cement is from about 0.25 to about 0.5.

In one embodiment, the ratio of aqueous solution to cement is about 0.45.

In one embodiment, the ratio of aqueous solution to cement is about 0.4.

In one aspect of the invention, there is provided a method for anchoring reinforcing member, dowel or anchor elements in a hole of a substrate comprising:
providing a grout composition as defined herein;
wetting said composition and introducing said composition in the hole; and
introducing the reinforcing member, dowel or anchor elements in the composition before any substantial hardening has occurred.

In one aspect of the invention, there is provided a method for anchoring reinforcing member, dowel or anchor elements in a hole of a substrate comprising:
providing a grout composition as defined herein,
wetting said composition with an aqueous solution; and
introducing a reinforcing member, dowel or anchor elements in the hole containing said composition before any substantial hardening has occurred.

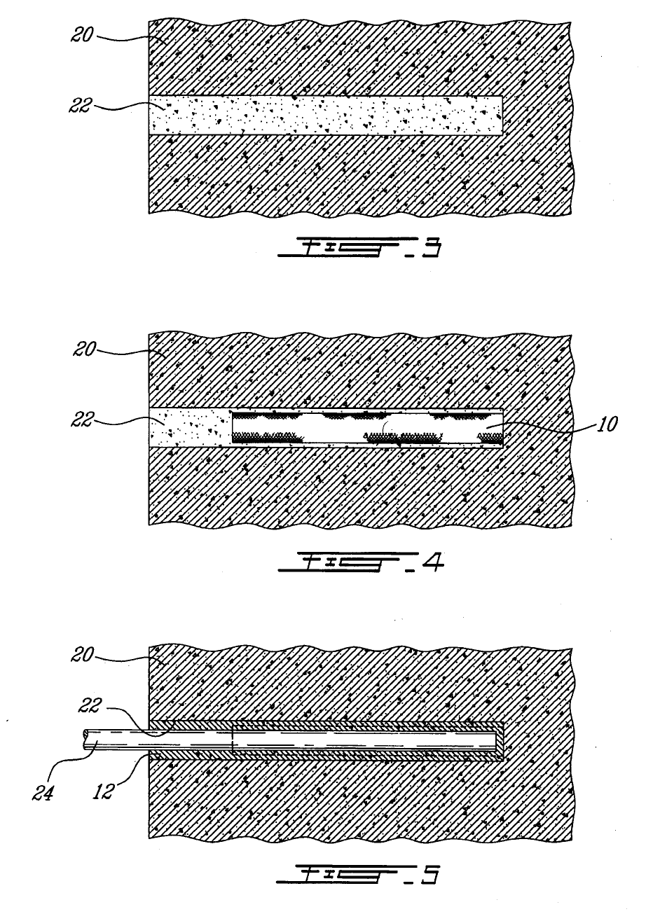

In accordance with one embodiment of the invention, FIG. 3 shows a substrate 20 that is a concrete block in which a hole 22 was prepared. As shown in FIG. 4, an anchoring capsule 10 (that has been soaked in water) is introduced within the hole 22. In FIG. 5, a rebar 24 is introduced within hole 22 causing the anchoring capsule to rupture and therefore release the wetted dry grout composition 12 to fill the hole as required (i.e. partly or completely).

Advantageously, the method for anchoring reinforcing member, dowel or anchor elements of the invention does not require rotation upon introducing the reinforcing member, dowel or anchor elements in the capsule.

The following examples are provided as illustration of some embodiments in accordance with the present invention.

### EXAMPLE 1

### Dry Grout Composition

A dry grout composition was prepared using the following ingredients and their relative proportion:
calcium aluminosulfate based hydraulic cement Rapid Set Cement® by CTS Cement : 11.25 kg (approximately 45%)
mineral filler (sand): 13.75 kg (approximately 54%)
thixotropic agent: EUCO-NIVO-P® obtained from Euclid Admixture Canada Inc. in proportion of 25g/25 kg Cement All® (approximately 0.1%)
   the amount % being based upon the total dry weight of the cement and filler.

### EXAMPLE 2

### Compressive Strength, Shrinkage and Pull Out Tests

Basic tests for compressive strength, shrinkage and pull out tests were performed in laboratory. Additional mineral fillers were added in different dosages and the amount of bleeding was observed. Tests were conducted on the grout before encapsulation in an unwoven polyester capsule and the tests were repeated with the grout inserted in the unwoven polyester capsule having a size of 19 mm×300 mm. The calcium aluminosulfate based hydraulic cement capsules were activated by simply immersing capsules in water at 20° C. A water/cement ratio of 0.40 was used.

The tests results for the capsule containing the grout composition of example 1 are as follows in Table 1:

TABLE 1
Compressive strength

| | | |
|---|---|---|
| ASTM C-109 | 20° C. | −1° C. |
| 4 hours | — | 17.9 MPa |
| 24 hours | 27.2 MPa | 21.1 MPa |
| 7 days | 30.5 MPa | 31.9 MPa |

Expansion/Shrinkage

| | |
|---|---|
| ASTM C-157 | |
| 28 days | +0.027% |
| ASTM C-1090 | |
| 28 days | +0.01% |

Setting time

| | |
|---|---|
| ASTM C-403 | |
| Initial setting time | 17 min |
| Final setting time | 21 min |

Freeze-thaw durability

| | |
|---|---|
| ASTM C-666 | |
| 300 cycles | |
| Dynamic modulus | 100% |

Slant shear test

| | |
|---|---|
| ASTM C-882 Mod | |
| 1 day | 9.7 MPa |
| 28 day | 17.9 MPa |

### EXAMPLE 3

### Pullout Tests with 600 MPa Reinforcing Steel

Pullout tests were performed using the capsule containing the grout composition of example 1.

A concrete block of 52.5 MPa was cast and reinforcing steel rebar (600 MPa) were installed in the drilled holes. Pullout tests using a hollow center hydraulic jack were performed and results are presented below in Table 2:

TABLE 2

| | | | | Pull out | |
|---|---|---|---|---|---|
| | | | | ASTM | 600 Mpa steel |
| Bar dia. | Hole length | | | E-488 | Elastic limit steel |
| mm | mm | Age | | kN | kN |
| 16 M | 300 | 4.5 | hrs | 110.3 | 121 |
| 16 M | 300 | 24 | hrs | 135.4* | 121 |
| 16 M | 300 | 7 | days | 144.7* | 121 |
| 16 M | 300 | 28 | days | 151.4* | 121 |
| 16 M | 400 | 28 | days | 147.8** | 121 |
| 20 M | 300 | 5 | hrs | 130.8 | 188 |
| 20 M | 300 | 24 | hrs | 177.1 | 188 |
| 20 M | 300 | 7 | days | 202.2* | 188 |
| 20 M | 300 | 28 | days | 212.7* | 188 |

*Maximum value obtained at constant load before load decreased due to bar deformation.
**Load applied continually until rebar failed after 45 mm elongation.

The purpose of the pull out test is to ensure that anchoring grout can develop adequate bond between substrate the anchoring grout as well as between the reinforcing element and the anchoring grout.

### EXAMPLE 4

### Pullout Tests with 400 MPa Reinforcing Steel

Pullout tests were performed using the capsule containing the grout composition of example 1.

A concrete block of 62.7 MPa was cast and reinforcing steel rebar (400 MPa) were installed in the drilled holes. Pullout tests using a hollow center hydraulic jack were performed and results are presented below in Table 3:

TABLE 3

| | | | | Pull out | |
|---|---|---|---|---|---|
| | | | | ASTM | 400 MPa steel |
| Bar dia. | Hole length | | | E-488 | Elastic limit steel |
| mm | mm | Age | | kN | kN |
| 15 M | 300 | 4 | hrs | 85.5* | 80 |
| 15 M | 300 | 24 | hrs | 108.9* | 80 |
| 15 M | 300 | 7 | days | 43.1*# | 80 |
| 15 M | 300 | 28 | days | 143.2*# | 80 |

*Maximum value obtained at constant load before load decreased due to bar deformation.
#Rebar failed.

The purpose of the pull out test is to evaluate whether the anchoring grout has developed adequate bond between substrate and the anchoring grout as well as between the reinforcing element and the anchoring grout.

### EXAMPLE 5

### Modified Dry Grout Compositions

Modified dry grout compositions were prepared by the addition of stannous sulfate or iron sulfate as reducing agent to the composition of Example 1. Table 4 illustrates entries A to K. Entry A is Cement All® by CTS Cement, entries B1, B2 and H are batches of a grout as described in example 1, entries C to G were prepared by the addition of stannous sulfate, in proportions indicated in their respective entry, to the composition of example 1. Entries I to K were prepared by the addition of ferrous sulfate, in proportions indicated in their respective entry, to the composition of Example 1.

The concentration of hexavalent chromium Cr(VI) was evaluated using an alkaline digestion (as described in EPA 3060A in STDM 20th Edition), followed by spectrophotometry analysis as described in method SM 3500-Cr B (STDM 20^{th} Edition) or EPA 7196 using a Varian Carry 50 spectrophotometer.
STDM=Standard methods for the examination of water and waste water 20^{th} Edition

The amount % being based upon the total dry weight of the dry grout composition (i.e. cement, filler, thixotropic agent and if any superplasticizer agent, air entraining agent and flyash and/or silica fume);

TABLE 4

| | Reducing agent | Cr(VI) |
|---|---|---|
| Entry | (amt %) | (ppm) |
| A | — | 21 |
| B1 (20° C.) | — | 55 |
| B2 | — | 27 |
| C | Stannous sulfate | 19 |
| | (0.1) | |
| D | Stannous sulfate | 15 |
| | (0.2) | |
| E | Stannous sulfate | 3.9 |
| | (0.3) | |
| F | Stannous sulfate | ND |
| | (0.5) | |
| G | Stannous sulfate | ND |
| | (1.0) | |
| H | — | 55 |
| I | Iron sulfate | 20 |
| | (0.6) | |
| J | Iron sulfate | 17 |
| | (0.8) | |
| K | Iron sulfate | 16 |
| | (1.0) | |

ND: undetectable

### EXAMPLE 6

### Modified Dry Grout Compositions Pull-Out and Compression Tests

The tests in Table 5 were conducted using the grouts described in the table below that are contained in capsules of unwoven polyester of 13 mm×200 mm. The composition of grouts in Table 5 are identical as those described in Example 5. The reinforcing steel rebar size was 15 mm diameter having a F′_{y} of 400 MPa. A hole was drilled in concrete at a depth of 200 mm and diameter of 19 mm. The pull out test was conducted at 10° C. and the compression test at 20° C.

The compression test was conducted under standard ASTM C-109 and the pull out test under ASTM E-488.

TABLE 5

| | compressive | pull | pull | pull | pull | pull | pull |
|---|---|---|---|---|---|---|---|
| | strenght 7 | out 4 | out 6 | out 1 | out 3 | out 7 | out 28 |
| | days (MPa) | hrs | hrs | day | days | days | days |
| Entry | ASTM C-109 | (KN) | (KN) | (KN) | (KN) | (KN) | (KN) |
| A | 45.5 | — | — | 92.44 | — | — | — |
| B1 | — | 78.8 | — | 86.17 | — | 102.89 | 109.16 |
| (20° C.) | | | | | | | |
| B2 | — | — | — | 89.66 | — | 89.3 | — |
| C | — | — | — | — | — | — | — |
| D | — | — | — | — | — | — | — |
| E | 38.3 | 0 | 39.71 | 93.84 | 94.53 | 91.14 | — |
| F | — | — | — | — | — | — | — |
| G | — | — | — | — | — | — | — |
| H | — | — | — | — | — | — | — |
| I | 37.4 | — | — | — | — | — | — |
| J | 38.2 | — | — | — | — | — | — |
| K | 36.9 | — | — | — | — | — | — |

### EXAMPLE 7

### Modified Dry Grout Compositions Pull-Out Tests

The composition of grouts in Table 6 are identical as those described in Example 5, the tests were conducted under same conditions as described in Example 6 with the exception that the temperature was 20° C.

TABLE 6

| | pull | pull | pull | pull | pull | pull |
|---|---|---|---|---|---|---|
| | out 4 | out 6 | out 1 | out 3 | out 7 | out 28 |
| | hrs | hrs | day | days | days | days |
| Entry | (KN) | (KN) | (KN) | (KN) | (KN) | (KN) |
| A | — | — | 94.81 | — | — | — |
| B1 | 78.8 | — | 86.17 | — | 102.89 | 109.16 |
| (20° C.) | | | | | | |
| B2 | — | — | 85.63 | — | — | — |
| C | — | — | — | — | — | — |
| D | — | — | — | — | — | — |
| E | 0 | 52.57 | 92.97 | 102.16 | 100.32 | — |
| F | — | — | — | — | — | — |
| G | — | — | — | — | — | — |
| H | — | — | — | — | — | — |
| I | — | — | — | — | — | — |
| J | — | — | — | — | — | — |
| K | — | — | — | — | — | — |

### EXAMPLE 8

### Modified Dry Grout Compositions Pull-Out Tests

The composition of grouts in entries A, B and E in Table 7 are identical as those described in Example 5 (Table 4), the pull-out tests were conducted under same conditions as those described in Example 6 using same steel reinforcing rebar, hole and capsule sizes. Tests were repeated in various holes at various time points as shown in Table 7 below at 10° C.

TABLE 7

Hole

| Cure | |
|---|---|
| time | Pull-out |

| Entry | Hole | (days) | reading | KN. | Average |
|---|---|---|---|---|---|
| A | 1 | 24 hrs | 5000 | 96.62 | 92.44 |
| | 2 | 24 hrs | 4600 | 88.26 | |
| | 3 | 24 hrs | 4800 | 92.44 | |
| | 4 | 7 | — | — | — |
| | 5 | 7 | — | — | |
| | 6 | 7 | — | — | |
| | 7 | 28 | — | — | — |
| | 8 | 28 | — | — | |
| | 9 | 28 | — | — | |
| B | 1 | 24 hrs | 4400 | 84.08 | 89.66 |
| | 2 | 24 hrs | 4600 | 88.26 | |
| | 3 | 24 hrs | 5000 | 96.62 | |
| | 4 | 7 | 1600 | 91.14 | 89.30 |
| | 5 | 7 | 1700 | 96.65 | |
| | 6 | 7 | 1400 | 80.12 | |
| | 7 | 28 | — | — | — |
| | 8 | 28 | — | — | |
| | 9 | 28 | — | — | |
| E | 1 | 4 hrs | 0 | 0.00 | 0.00 |
| | 2 | 4 hrs | 0 | 0.00 | |
| | 3 | 4 hrs | 0 | 0.00 | |
| | 4 | 6 hrs | 600 | 36.04 | 39.71 |
| | 5 | 6 hrs | 800 | 47.06 | |
| | 6 | 6 hrs | 600 | 36.04 | |
| | 7 | 24 hrs | 5000 | 96.62 | 93.84 |
| | 8 | 24 hrs | 4800 | 92.44 | |
| | 9 | 24 hrs | 4800 | 92.44 | |
| | 10 | 3 | 4800 | 92.44 | 94.53 |
| | 11 | 3 | 5000 | 96.62 | |
| | 12 | 7 | 1500 | 85.63 | 91.14 |
| | 13 | 7 | 1600 | 91.14 | |
| | 14 | 7 | 1700 | 96.65 | |
| | 15 | 28 | — | — | — |
| | 16 | 28 | — | — | |
| | 17 | 28 | — | — | |

### EXAMPLE 9

### Modified Dry Grout Composition Pull-Out Tests

The composition of grouts in entries A, B and E in Table 8 are identical as those described in Example 5 (Table 4), the pull-out tests were conducted under same conditions as those described in Example 6 using same steel reinforcing rebar, hole and capsule size. Tests were repeated in various holes at various time points as shown in Table 8 at 20° C.

TABLE 8

Hole

| Cure | |
|---|---|
| time | Pull-out |

| Entry | Hole | (days) | reading | KN. | Average |
|---|---|---|---|---|---|
| A | 1 | 24 hrs | 1700 | 96.65 | 94.81 |
| | 2 | 24 hrs | 1700 | 96.65 | |
| | 3 | 24 hrs | 1600 | 91.14 | |
| | 4 | 7 | — | — | — |
| | 5 | 7 | — | — | |
| | 6 | 7 | — | — | |
| | 7 | 28 | — | — | — |
| | 8 | 28 | — | — | |
| | 9 | 28 | — | — | |
| B | 1 | 24 hrs | 1400 | 80.12 | 85.63 |
| | 2 | 24 hrs | 1400 | 80.12 | |
| | 3 | 24 hrs | 1700 | 96.65 | |
| | 4 | 7 | — | — | — |
| | 5 | 7 | — | — | |
| | 6 | 7 | — | — | |
| | 7 | 28 | — | — | — |
| | 8 | 28 | — | — | |
| | 9 | 28 | — | — | |
| E | 1 | 4 hrs | 0 | 0.00 | 0.00 |
| | 2 | 4 hrs | 0 | 0.00 | |
| | 3 | 6 hrs | 900 | 52.57 | 52.57 |
| | 4 | 6 hrs | 900 | 52.57 | |
| | 5 | 6 hrs | 900 | 52.57 | |
| | 6 | 24 hrs | 1700 | 96.65 | 89.30 |
| | 7 | 24 hrs | 1400 | 80.12 | |
| | 8 | 24 hrs | 1600 | 91.14 | |
| | 9 | 3 | 1900 | 107.67 | 102.16 |
| | 10 | 3 | 1700 | 96.65 | |
| | 11 | 7 | 1700 | 96.65 | 100.32 |
| | 12 | 7 | 1900 | 107.67 | |
| | 13 | 7 | 1700 | 96.65 | |
| | 14 | 28 | — | — | — |
| | 15 | 28 | — | — | |
| | 16 | 28 | — | — | |

1. A dry grout composition comprising:
a calcium aluminosulfate based hydraulic cement;
a mineral filler;
a thixotropic agent; and
a superplasticizer agent.

2. A dry grout composition comprising:
a calcium aluminosulfate based hydraulic cement;
a mineral filler;
a thixotropic agent;
a superplasticizer agent;
an air entraining agent; and
optionally flyash and/or silica fume.

3-27. (canceled)

28. An anchoring capsule for use in anchoring a reinforcing member, dowel or anchor elements in a hole of a substrate, the capsule comprising:
a water permeable encapsulating means; and
a grout composition as comprising a calcium aluminosulfate based hydraulic cement; a mineral filler; a thixotropic agent; and a superplasticizer agent;
said grout composition being encapsulated within said encapsulating means.

29. An anchoring capsule for use in anchoring reinforcing member, dowel or anchor elements in a hole of a substrate, the capsule comprising:
a water permeable encapsulating means; and
a grout composition comprising a calcium aluminosulfate based hydraulic cement, a mineral filler, a thixotropic agent, a superplasticizer agent, an air entraining agent and optionally a flyash and/or silica fume,
said grout composition being encapsulated within said encapsulating means.

30. The anchoring capsule as defined in claim 28, wherein the encapsulating means is made of polyester.

31. The anchoring capsule as defined in claim 30, wherein the polyester is unwoven polyester.

32. A method for anchoring reinforcing member, dowel or anchor elements in a hole of a substrate comprising:
providing an anchoring capsule as defined in claim 28;
soaking said capsule in an aqueous solution;
introducing said capsule in the hole; and
introducing a reinforcing member, dowel or anchor elements in the capsule before any substantial hardening has occurred.

33. A method for anchoring reinforcing member, dowel or anchor elements in a hole of a substrate comprising:
providing an anchoring capsule by introducing a dry grout composition comprising a calcium aluminosulfate based hydraulic cement, a mineral filler, a thixotropic agent, a superplasticizer agent, an air entraining agent and optionally a flyash and/or silica fume in a water permeable encapsulating means;
soaking said capsule in an aqueous solution;
introducing said capsule in the hole; and
introducing a reinforcing member, dowel or anchor elements in the capsule before any substantial hardening has occurred.

34. A method for anchoring reinforcing member, dowel or anchor elements in a hole of a substrate comprising:
providing a grout composition comprising a calcium aluminosulfate based hydraulic cement, a mineral filler, a thixotropic agent, a superplasticizer agent, an air entraining agent and optionally a flyash and/or silica fume in a capsule;
wetting said composition with an aqueous solution;
introducing said capsule in the hole; and
introducing a reinforcing member, dowel or anchor elements in the capsule before any substantial hardening has occurred.

35-36. (canceled)

37. A method for anchoring reinforcing member, dowel or anchor elements in a hole of a substrate comprising:
providing a grout composition comprising a calcium aluminosulfate based hydraulic cement, a mineral filler, a thixotropic agent, a superplasticizer agent, an air entraining agent and optionally a flyash and/or silica fume;
wetting said composition;
introducing said composition in the hole; and
introducing a reinforcing member, dowel or anchor elements in the wet composition before any substantial hardening has occurred.

38-40. (canceled)

41. The anchoring capsule as defined in claim 29, wherein the calcium aluminosulfate based hydraulic cement amount is from about 40% to about 70%;
the mineral filler amount is from about 30% to about 60%;
the thixotropic agent is from trace amount to about 5%;
the superplasticizer agent is from trace amount to about 5%;
the air entraining agent is from trace amount to about 5%; and
optionally the flyash and/or silica fume from trace to about 10%;
said amount being based upon the total dry weight of said composition for a total of 100%.

42. The anchoring capsule as defined in claim 29, wherein the the calcium aluminosulfate based hydraulic cement amount is from about 40% to about 50%
the mineral filler at about 45% to about 55%;
the thixotropic agent at about less than 1%;
the superplasticizer agent at about less than 2%;
the air entraining agent at about less than 1%; and
optionally the flyash and/or silica fume from trace amount to about 10%

43. The anchoring capsule as defined in claim 29, wherein the cement contains less that 30% of alumina.

44. The anchoring capsule as defined in claim 29, wherein the cement contains between about 10% and about 25% of alumina.

45. The anchoring capsule as defined in claim 29, wherein the cement contains less than about 15% of alumina.

46. The anchoring capsule as defined in claim 29, wherein the thixotropic agent includes a cellulose-based colloidal agent.

47. The anchoring capsule as defined in claim 29, wherein the grout composition contains from about 0.01% to about 5% thixotropic agent.

48. The anchoring capsule as defined in claim 29, wherein the grout composition contains about 1% thixotropic agent.

49. The anchoring capsule as defined in claim 29, wherein the grout composition contains less than about 0.1% thixotropic agent.

50. The anchoring capsule as defined in claim 29, wherein the grout composition contains from about 40% to about 60% mineral filler.

51. The anchoring capsule as defined in claim 29, wherein the grout composition contains from about 45% to about 55% mineral filler.

52. The anchoring capsule as defined in claim 29, wherein the mineral filler is sand.

53. The anchoring capsule as defined in claim 29, wherein the superplasticizer agent is melamine sulfonate based plasticizer.

54. The anchoring capsule as defined in claim 29, wherein the grout composition contains from about 0.01% to about 5% of the superplasticizer.

55. The anchoring capsule as defined in claim 29, wherein the grout composition contains about 1% of the superplasticizer.

56. The anchoring capsule as defined in claim 29, wherein the grout composition contains from about 0.01% to about 5% of the air entraining agent.

57. The anchoring capsule as defined in claim 29, wherein the grout composition contains less than about 1% of the air entraining agent.

58. The anchoring capsule as defined in claim 29 further comprising a chromium(VI)-reducing agent.

59. The anchoring capsule as defined in claim 58 wherein said chromium(VI)-reducing agent is stannous sulfate or ferrous sulfate.

60. The anchoring capsule as defined in claim 58 wherein said chromium(VI)-reducing agent is stannous sulfate.

61. The anchoring capsule as defined in claim 58 wherein said chromium(VI)-reducing agent is ferrous sulfate.
